(19) United States
(12) Patent Application Publication
(10) Pub. No.: US 2009/0163131 A1
(43) Pub. Date: Jun. 25, 2009

(54) PERSONAL ENVIRONMENT AIRFLOW CONTROLLER

(76) Inventors: Douglas Stuart Walkinshaw, Ottawa (CA); Raymond H. Horstman, Snohomish, WA (US)

Correspondence Address: CALFEE HALTER & GRISWOLD, LLP, 800 SUPERIOR AVENUE, SUITE 1400, CLEVELAND, OH, 44114, US

(21) Appl. No.: 12/301,270

(22) PCT Filed: May 18, 2007
(86) PCT No.: PCT/CA2007/000889

§ 371 Date: Nov. 18, 2008

Related U.S. Application Data
(60) Provisional application No. 60/801,068, filed on May 18, 2006.

(51) Int. Cl. B64D 13/06; F24F 13/28; B60H 1/34; B60H 3/06; F24F 13/04

(52) U.S. Cl. 454/76; 96/223; 55/385.3; 95/273; 454/265

(57) ABSTRACT

The apparatus and method provide an airflow to a person or group of persons or a space such as within an airplane cabin or cockpit, operating in conjunction with an air supply which produces a high velocity air stream, such as an aircraft gasper (14). Existing systems may filter, purify and/or clean the air supplied to the occupant, and the air exiting the personal air outlet may be adjusted to a relatively high velocity. The narrow, high velocity stream of air forms a turbulent boundary layer, which tends to entrain potentially foul air from the surrounding region and directs it towards the passenger. The airflow from the apparatus and method may have reduced velocity and lower thermal and humidity gradient and may be treated to remove locally-originating contaminants. The apparatus includes a housing which receives a primary stream of air, such as from an aircraft gasper (14) or personal air outlet. A secondary inlet (17) into the housing admits ambient air into the housing interior A mixing chamber (30) within the housing receives the primary air stream and captures its momentum to entrain ambient air entering the housing through the secondary inlet. The combined streams are discharged, typically towards an occupant of the cabin. The ambient air may be treated before or after it is entrained so as to remove or disable pathogens or other air contaminants including gases and particles, or the ambient air may be drawn from a source distant from sources of air contamination and/or undesirable thermal conditions.

This application claims the Convention Priority benefit of U.S. Patent application No. 60/801,068 filed on May 18, 2006, which is incorporated in its entirety herein by reference.

### FIELD OF THE INVENTION

The present invention relates to air ventilation, filtration, purification, and cleaning. It relates more particularly to an apparatus for attachment to or use with an air supply outlet, such as an airplane gasper (personal air outlet), and to the local delivery and circulation of clean air with reduced air stream thermal and humidity gradients relative to ambient air.

### BACKGROUND OF THE INVENTION

Air contaminants such as chemicals and pathogenic organisms, and ventilation air supply thermal and humidity gradients, particularly in high occupancy enclosed spaces such as in transportation vehicles, can present health and comfort concerns due to the limitations of existing ventilation systems. Existing centralized ventilation systems depend on conventional diffusers to deliver supply air locally. They may filter, purify and/or clean the air delivered and thus provide a limited amount of local dilution of air contaminants and central removal and/or killing of airborne pathogens, removal of particles, and removal, dilution or conversion of airborne chemicals to less hazardous chemicals. Centralized filtration, air purification and air cleaning have limitations: pathogens and air contaminants, for example, can still be circulated locally by the natural airflow patterns that are generated by the air supply diffusers, occupant movement and other forces, and may travel several seat rows forward and aft and from side to side in the case of transportation vehicles before being drawn from the occupied space to a central air cleaner and conditioner system and recirculated.

In an aircraft, trains, buses and the like, as in buildings or other environments, ventilation air is typically provided by a central environmental control system (ECS) or heating, ventilation and air-conditioning (HVAC) system. The system typically delivers a supply of thermally conditioned and filtered, purified and/or cleaned air through ducting to room air diffusers and in the case of aircraft and other passenger vehicles, to gaspers or personal air outlets (PAOs).

PAOs in aircraft are typically located in a Passenger Service Unit (PSU) above the passenger seats, and above crew seats, crew quarters and in galleys. They provide high velocity air directly to the occupants primarily as a cooling rather than air quality control mechanism. Passengers typically are able to control the direction and quantity of airflow from their PAO, which increase local air velocity around the passengers and thereby provide some thermal comfort for the passengers and crew. PAOs are typically low volumetric flow devices that contribute little to the improvement of air quality in the cabin. The flow of air to supply the PAOs is provided by relatively small supply lines leading to the PAOs. The air exiting the PAOs may be adjusted to a relatively high velocity to provide the desired cooling effect. An unwanted side effect is that the narrow, high velocity stream of air forms a turbulent boundary layer, which tends to entrain air from the immediately surrounding region and directs the combined airflow towards the passenger. This effect can draw in contaminants from the surrounding region, for example airborne microbes from a neighboring passenger or other source in the immediate vicinity of the PAO. As a result, even if the PAO air supply is itself filtered, purified and/or cleaned (which may or may not be the case), the use of a PAO can increase the level of contaminants bathing a passenger if the local level of contamination is high, despite the perception of purified air surrounding a passenger using the device.

Existing systems may filter, purify and/or clean the air supplied to the PAO or supplied by the PAO to the occupant, but these systems do not provide adequate treatment of entrained cabin air delivered to the occupant along with the PAO air. The relatively high velocity stream of air exiting the PAO tends to entrain a large volume of air in the region adjacent to the PAO nozzle, as momentum is exchanged in a turbulent shear layer between the two. This region will thus tend to draw in air from the region surrounding the PAO, including any contaminants therein. Thus, even if the air exiting the PAO has been purified, contaminants from the surrounding region can be drawn into the PAO air stream.

Entrainment of ambient air in the flow of ventilation air can thus result in pathogens, dust and odors being drawn into the occupant's personal air supply, in particular by the turbulent boundary layer which forms near the PAO nozzle where the air velocity is highest. When occupants and crew adjust their PAOs to increase air velocity and personal comfort, they may in fact be increasing their exposure to airborne contaminants.

There is a need for a PAO-type ventilation system for an enclosed cabin that reduces occupant exposure to one or both of a) pathogens, irritants and odors generated in the cabin by people, materials and systems, and b) air contaminants from the outside air used to ventilate the cabin such as engine exhaust combustion contaminants while on the runway, or from the engine compressor bearing lubricating oil if there is leakage during flight or on the ground. There is also a need to improve ventilation effectiveness in the individual occupant breathing zones. There is also a need to improve thermal comfort, for example particularly during boarding and while awaiting take-off in warm humid weather.

Personal air filtration systems and external air filtration systems which attach to a PAO are known. U.S. Pat. No. 6,780,213 to Chang et al. discloses a personal air cleaning apparatus which draws in air from a contaminated zone, filters, purifies and/or cleans the air and discharges it. The device disclosed by Chang requires the use of a fan-driven sucking/discharging unit to draw in contaminated air. Both U.S. Pat. No. 5,567,230 to Sinclair and U.S. Pat. No. 6,610,116 to Avery provide a filter, purifier and/or cleaner module configured to attach to the PAO air supply nozzle to filter the PAO air as it passes through the module. However, these methods and systems do not address the entrainment and ECS limited air supply problems discussed above. Rather, these devices primarily treat only the air supplied by the ECS to the PAO and do not treat air contaminants in the entrained cabin air surrounding or passing between occupants, nor do they provide much relief to occupants and/or equipment from the thermal gradients generated by typical gaspers and other PAO's. These devices are not as highly effective as desirable, and may actually increase the spread of airborne disease to passengers and crew using them under certain conditions.

Filtration systems designed to fit in constricted spaces, such as the cabin of an aircraft are also known. For example, U.S. Pat. No. 6,585,792 to Schneider et al., provides an air filter assembly with a replaceable filter. However, the Schneider assembly is not incorporated into the cabin or PAO air supply and may not significantly improve the volume of filtered and ventilated airflow provided to occupants. U.S. Pat. No. 6,787,782 to Krosney et al. discloses a system using ultraviolet light to sterilize air in a confined space such as a vehicle or aircraft. The Krosney system acts on air within a conduit, such as within the PAO supply of an airplane, but may not address direct passenger-to-passenger, passenger-to-crew and crew-passenger air contaminant and pathogen spread. The Krosney system also may not significantly improve the ventilation flow provided to occupants.

It is an object of the present invention to provide an improved system which when used with an existing source of ventilation air, may provide a supply of filtered, purified and/or cleaned air to passengers and crew, and which may mitigate against air contaminants emanating from neighboring occupants and equipment, and/or which improves thermal conditioning of a space for improved occupant and/or equipment comfort and performance.

### SUMMARY OF THE INVENTION

The invention relates to air treatment of ventilation air supplied to the interior of an enclosed space such as an aircraft or other cabin, although it is not limited to this particular application and includes also ventilation air supplied to other end users and uses. The invention relies upon the momentum of a relatively high velocity stream of air exiting an air supply outlet to serve as a primary flow to entrain a secondary flow comprising ambient air from a region of the space. By enclosing the outlet within an enclosed housing and directing the airflow into a mixing chamber, one may harness this effect so as to create a reduced pressure suction in a region of the housing interior, referred to as the entrainment section of the housing, and entrain ambient air from outside the housing, which enters the housing through one more inlets. The ambient air entrained in airflow can originate in the breathing zone of the occupants and therefore contain the various gases and particulates associated with human metabolism and activity as well as contaminants from other sources. According to other aspects, ambient air can be entrained which originates from locations remote from the air supply outlet, which may tend to be at more desirable temperatures or air quality, and combined with the supply air stream. The incoming ambient air may be treated prior to or subsequent to entering the mixing chamber. For this purpose, treatment may comprise filtering, cleaning and/or purifying of the ambient air. The entrainment of ambient air is achieved by generating a region of reduced air pressure within the housing which may be used to draw the ambient air through a filter, purifier, and/or cleaner. The combined entrained or secondary air and the primary air supply from the gasper or other air outlet are combined in a mixing chamber and discharged at a lower velocity than the primary air supply velocity, thus reducing any subsequent entrainment which may occur downstream from the device outlet. In various aspects the invention may increase air circulation to occupants enable treatment of air contaminants in the ambient air it entrains and in the primary air flow. In another aspect the mixing of the entrained ambient air with the primary air flow in the mixing chamber may reduce the thermal and humidity gradients that otherwise exist between the air exiting the air outlet and the ambient air.

The primary flow air may itself be treated and the combined effect of the two treating systems may improve air quality locally at air discharge outlets.

According to one aspect, the invention relates to an apparatus for use in combination with a source of pressurized air, said source comprising an outlet for discharge of a high velocity primary air stream. The source may comprise a conventional gasper or PAO of the type used in an aircraft (or a similar structure used elsewhere) or alternatively the source may comprise any other type of air outlet or diffuser which releases a stream of breathable air in a relatively high velocity directed stream or may be made to release such high velocity air stream. According to this aspect the apparatus comprises:

a housing having a primarily inlet to receive said air stream from said gasper or other air outlet, an outlet for discharge of air, and a secondary inlet for the intake of ambient air; and

an air mixing chamber at least partly within the interior of said housing having open first and second ends, said first end having at least one opening for receiving an air stream from said gasper and additional air from the interior of said chamber, said second end for discharging air outwardly from said apparatus, said mixing chamber being configured to entrain ambient air from the interior of said housing when said air stream is directed through said chamber so as to discharge from said second end a combined stream composed of said ambient air and air from said gasper.

The apparatus may include an air treatment system for treating the ambient air entering the secondary inlet by filtering, purifying and/or cleaning this air either before or after it enters the secondary inlet. Alternatively or in addition, in order to introduce relatively clean air into the apparatus, the secondary inlet receives its airflow from a location distant from the housing and operatively connected thereto by a conduit.

According to one aspect, the air treatment system is a filter, purifier and/or cleaner abutting a wall of the housing which is provided with one or more openings into the interior of the housing, wherein air drawn into the interior of said housing through the opening or openings passes through said treatment system. The ambient air drawn through the system is thus treated as it enters the housing interior.

The secondary inlet may take several forms, including one or more walls of the housing having perforations or other openings therein, which are covered by a filter, purifier and/or cleaner which comprises an air treatment system for the incoming ambient air. Alternatively, the secondary inlet may consist of an inlet tube which receives ambient air from a location at a distance from the housing. The air treatment system, if provided, may be located at any convenient location along the path of the incoming ambient air, such as at the intake end of the tube.

According to another aspect, the air treatment system may comprise a UV source or other sterilizing or contaminant gas removal system, such as a sorbent material such as charcoal.

According to another aspect, the housing includes at least one wall, and the secondary inlet consists of one or more perforations within the wall, with a treatment means such as a media filter, a purifier and/or a cleaner such as a sorbent, electronic capture or an oxidation device abutting or adjacent to the wall such that the incoming ambient air flows through the treatment means. The perforated wall may consist of the entire or substantially all of the sidewall of the housing and optionally an end wall of the housing. The treatment means can be either inside or outside of the housing.

According to another aspect, the mixing chamber is substantially tubular. The chamber may comprise a straight tube or curving or coiled structure, or include internal baffles to provide this effect internally. Alternatively, the chamber may comprise one or more walls which taper outwardly towards said second end to form a truncated pyramidal shape. Preferably, the mixing chamber exceeds one inch in length. More preferably it exceeds two inches in length and in another aspect it exceeds six inches in length.

According to another aspect there is provided a manifold within the interior of said housing positioned to receive said air stream from the outlet, having a plurality of openings for directing a plurality of air streams into the first end of said mixing chamber.

According to one aspect, the apparatus directly attaches to a gasper or similar structure. According to another aspect, the apparatus may indirectly attach to the gasper, for example by mounting onto a panel immediately surrounding a gasper without physically contacting the gasper itself. The apparatus may be a readily removable portable apparatus suitable for carrying onboard by a passenger for temporary personal use, or alternatively being more or less permanently installed.

According to another aspect, the apparatus may replace a conventional gasper system. According to this aspect, the housing is built into the aircraft or other cabin, for example within the PSU. A plenum for delivering pressurized air enters the housing and branches into a plurality of sources of pressurized air within the housing. Each such source of pressurized air is associated with a separate (optionally independently controlled) passenger air discharger. The apparatus includes a corresponding plurality of mixing chambers each associated with a corresponding source, said plurality of chambers being optionally separated by internal dividers within the housing. In this version, the chambers may each be sealed with a cap at the first end and said multiple air sources each comprise a jet orifice entering said chamber through an opening in said cap. The first end of said chamber includes additional openings within or adjacent to the cap to permit ambient air from the interior of said housing to enter into said chambers.

According to another aspect, the invention relates to an airflow supply apparatus for a vehicle, including without limitation an aircraft, land vehicle or watercraft, to remove contaminants and provide increased flowrate to an interior of the vehicle. The apparatus according to this aspect comprises:

a) a housing having at least one intake opening for receiving intake air from the interior of the vehicle into the housing and further having at least one exit for discharging air from the housing toward the interior;

b) a filter mounted on the housing for removing contaminants from said intake air; and

c) a nozzle in communication with a supply of pressurized air for releasing a flow of pressurized air into the housing.

According to this aspect, the nozzle is positioned generally adjacent to the opening of the housing such that the flow of pressurized air entrains said intake air from the interior of the vehicle to flow into the housing, through the filter, and through the exit for discharge from the housing together with air from the nozzle.

According to another aspect, the invention relates to a method for delivering a stream of at least partially purified cabin air to an occupant, by supplying an air mixing chamber to receive a stream of pressurized air, for example from an aircraft gasper, generating a plume of air within the chamber which has a turbulent boundary layer, entraining additional ambient air within the boundary layer and thereby drawing additional ambient air into the chamber, and discharging the combined air stream from an opposed end of the chamber. A filter, air cleaner and/or purifier is optionally also provided, and the ambient air is filtered for pathogens and particulates such as combustion and oil aerosols, purified of harmful pathogens, and/or cleaned of odorous, noxious and/or toxic gases before it enters the chamber so as to remove contaminants. Preferably, this method is used to deliver a stream of air to an occupant within a relatively crowded environment such an airplane cabin, in which there is a risk of contamination from airborne pathogens from neighboring passengers. Accordingly, the method also relates to a method to reduce the exposure to pathogens and other airborne contaminants in a crowded environment.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the present patent specification as a whole. Any directional references included herein such as “horizontal”, “vertical” and the like are unless otherwise specified or if required by the context, purely for convenience of description and are not intended to limit the scope of the invention. In a similar fashion, any dimensions, choices of materials and the like described in the detailed description herein are unless otherwise specified, presented purely as an illustrative example and are not intended to limit the scope of the invention.

As well, it will be seen that although the invention has been described primarily by reference to its application in aircraft, the invention may readily be used in many other applications, including without limitation trains and other vehicles, spacecraft, watercraft and stationary uses.

### BRIEF DESCRIPTION OF THE DRAWINGS

These and other advantages of the invention will become apparent upon reading the following detailed description and upon referring to the drawings in which:

FIG. 1 is a plan view from below of a first embodiment of the portable ventilation and treatment apparatus;

FIG. 2 is a sectional view along line 2-2 of FIG. 1;

FIG. 2A is a sectional view showing a variant of the mixing chamber of the first embodiment;

FIG. 3 is a side sectional view of a second embodiment;

FIG. 4 is a plan view of a third embodiment;

FIG. 5 is a cross-sectional view of line 5-5 of FIG. 4;

FIG. 6 is a side sectional view of a fourth embodiment;

FIG. 7 is a cross-sectional view of an airplane cabin showing the installation of a typical conventional gasper system;

FIG. 8 is a side view, partly in section, of a fifth embodiment which may be retrofitted into a personal storage unit of an aircraft or the like;

FIG. 9 is a side view, partly in section, of a sixth embodiment;

FIG. 10 is a side view, partly in section, of a seventh embodiment;

FIG. 11 is a side view, partly in section, of an eighth embodiment;

FIG. 12 is a schematic view of a ninth embodiment;

FIG. 13 is a plan view of the ninth embodiment;

FIG. 14 is a schematic view of a tenth embodiment;

FIG. 15 is a sectional view of a portion of the air supply tube, showing a first variant thereof;

FIG. 15a is a sectional view along line 15-15 of FIG. 15

FIG. 16 shows a second variant of the air supply tube;

FIG. 16a is a plan view from the front of FIG. 16;

FIG. 17 shows a third variant of the air supply tube;

FIG. 17a is a sectional view along line 17-17 of FIG. 17;

FIG. 18 shows a fourth variant of the air supply tube;

FIG. 18a is a plan view from the front of FIG. 18;

FIG. 19 is a perspective view of a mixing chamber according to one aspect of the invention;

FIG. 20 is a schematic view of a pressurized air outlet for supplying a primary air stream to the apparatus;

FIG. 21 is a schematic perspective view of a portion of the apparatus according to an aspect of the invention;

FIG. 22 is a schematic perspective view of a mixing chamber according to one aspect, showing also computational fluid dynamic (CFD) values representative of the performance of the device;

FIG. 23 is a perspective view of a portion of the device, showing additional CFD values achievable during testing of the device;

FIG. 24 is a schematic illustration of airflow patterns generated by a conventional gasper and an apparatus according to the invention mounted to a gasper;

FIG. 25 is a perspective view of a portion of the apparatus according to the fifth embodiment of the invention.

The present invention will now be further described and explained by way of a non-limiting description of certain detailed embodiments.

### DETAILED DESCRIPTION

In the following description, similar features in the drawings have been given identical reference numerals where appropriate. All dimensions described or suggested herein are intended solely to illustrate an embodiment. Except as specifically indicated, these dimensions are not intended to limit the scope of the invention which may depart from these dimensions.

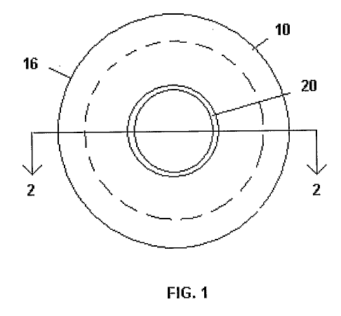

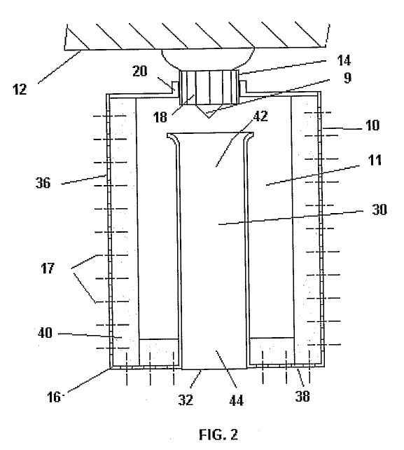

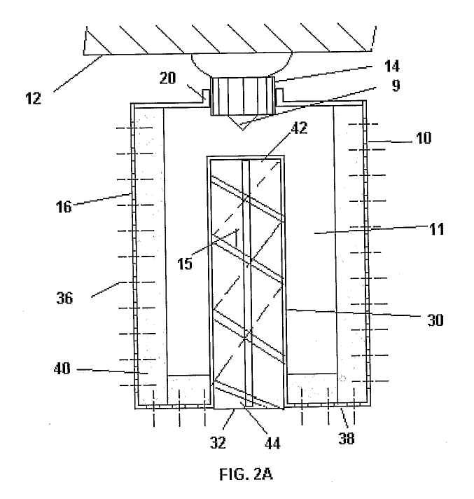

FIGS. 1 and 2 show a first embodiment of a ventilation and filtration, purification and/or cleaning apparatus 10 according to the present invention, intended to be installed over an existing conventional gasper. In other embodiments, the system may be built into or otherwise more or less permanently incorporated with a conventional gasper structure as described later. It will also be apparent to those skilled in the art that with modifications the system may be used in connection with other types of ventilation air outlets, for example as may be found in an aircraft, an automobile or other vehicles, or in a stationary source.

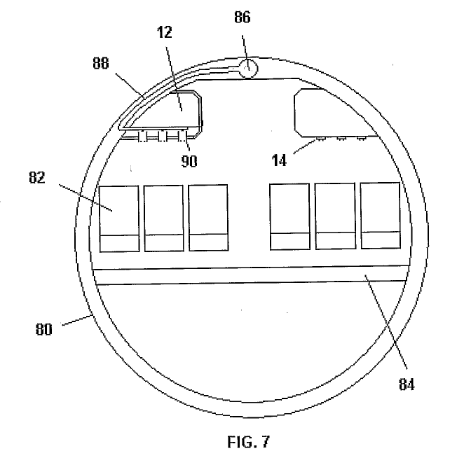

The apparatus is configured to attach to a gasper or personal air outlet (PAO) 14, commonly found on the underside of a personal storage unit (PSU) 12 in an aircraft (see also FIG. 7). It may be provided as a portable, self-contained unit for temporary installation by a passenger, or it may be substantially non-removable. The apparatus is generally contained within a housing 16, which includes a pressurized primary air supply inlet port 18. The port 18 is surrounded by a flange or rim 20 which can encircle the gasper outlet 14 for attachment thereto by any convenient attachment means, such as friction fit, sticky tape, glued attachment or the like. The outlet of the gasper 14 thus protrudes in the interior of the housing 16. Air exiting the gasper outlet 14 thus directly enters into the interior of the housing 16. Typical dimensions of the housing 16 are about 6 inches in diameter by 2 inches in height, although these dimensions can vary to accommodate internal components of various dimensions. Conveniently, the housing will be openable so as to permit replacement of the filter, described below. For example, the housing may include a removable bottom plate or cap, such as a friction-fit or screw-off bottom cap. As will be seen, the dimensions of the housing are selected so as to provide a suitable surface area for filtration, purification and/or cleaning of incoming air and sufficient space to house a mixing chamber which is described in more detail below. The housing 16 includes within its interior a mixing chamber 30 and an outlet port 32. The housing is effectively sealed against air inflow except through the inlet port 18 and the secondary inlets described below.

The housing 16 comprises side walls 36 and a bottom cap or wall 38, all or some of which include one or more secondary inlets 17 to allow ambient cabin air to pass into the interior of the housing 16. The housing is sealed against air inflow apart from the primary and secondary inlets. The secondary inlets may comprise perforations in the housing walls. The housing 16 may comprise any convenient shape—in the example herein the housing is cylindrical. The housing 16 is fully or partly lined within its interior with a filter 40 which is located adjacent to the side walls 36 and bottom wall 38 of the housing 16 to filter ambient cabin air which enters the apparatus 10 through the housing walls. Alternatively, the filter 40 may cover the exterior of the housing walls so as to be readily replaceable or the housing and filter may be a single unit. The filter medium is preferably selected to remove contaminant gases, particulates and/or airborne pathogens from the ambient cabin air. A suitable filter comprises filter media paper.

In other embodiments, the filter described herein and in the embodiments which follow may be replaced or augmented with a purifier or cleaner such as an ultra violet light generator or a charcoal sorbent. Those skilled in the art will recognize that numerous air filters, cleaners and purifiers are known to the art, and may become known to the art during the pendency of this patent, and that such devices may be readily adapted for use with the present invention. These include sorbents such as charcoal, and electronic capture and oxidation devices.

Preferably, the filter 40 is highly permeable to minimize the required pressure drop across the filter, purifier and/or cleaner, for example by providing a relatively large, low-pressure drop media filter so as to maximize the efficiency of the filter while still retaining its ability to remove and/or disable contaminants such as pathogenic organisms. The filter 40 covers all or substantially all of the 3 inch diameter perforated side walls and the bottom wall of the housing 16.

The interior of the housing 16 defines a space which lies between the filter 40 and the mixing chamber 30 which is mounted within the interior of the housing 16. The region of the housing interior which is external to the mixing chamber is termed the entrainment section 11; during operation, this is a region of lower relative pressure than the ambient air pressure. In one embodiment, the chamber 30 is generally tubular and cylindrical although it will be seen that other configurations may be employed. The chamber 30 is oriented generally vertically to receive downwardly-directed airflow from a conventional gasper, and has open upper and lower ends 42, 44. The open upper end 42 is positioned to receive a primary air stream from the gasper outlet nozzle 9, and spaced apart from the outlet of the gasper 14 or otherwise configured so as to leave a gap between the gasper 14 and the open end 42. This gap permits a secondary flow of air from within the interior of the housing to enter into the chamber 30 along with air from the gasper. The nozzle outlet 9 may protrude into the open end 42 or remain wholly outside the mixing chamber 30. As well, other arrangements may be provided to introduce the secondary air flow into the chamber 30, as will be seen by those skilled in the art.

The mixing chamber 30 is positioned and configured to receive the airflow from the gasper and to capture the momentum of this relatively high velocity primary airflow to draw in or entrain a secondary flow of ambient air from the interior of the housing 16 entrainment section. It is believed that this occurs largely or entirely at the boundary layer of the turbulent plume or stream of high velocity air as it exits the gasper outlet. The chamber 30 has a larger, and preferably substantially larger, inside diameter than the throat diameter of the gasper outlet, such that the air plume generated by air exiting the gasper is permitted to expand within the chamber 30 so as to create a suction and entrain ambient air into the entrainment chamber 11 and thence into the mixing chamber 30. Depending on the dimensions of the chamber 30 and the mass, area and velocity of the air stream entering the chamber 30, additional ambient air in a volume of up to ten times or more relative to the gasper air discharge may be entrained. It is believed that the number of high pressure outlets (for example, multiple jets as discussed below), the shape and the dimensions, including both the inlet and outlet area and length, of the chamber 30 as well as its distance from the gasper outlet, and jet outlets may be varied for obtaining efficient entrainment and filtration, purification and/or cleaning of the ambient cabin air.

The dimensions of the chamber 30 are 1.625 inches inside diameter and 2 inches long. The inside diameter and length of the chamber 30 may vary depending on the system requirements, for example the inside diameter may range from about 0.5 inches to 4 inches and the length from 1 inch to 12 inches or more. Preferably the inside diameter is about 1.5 inches and the length is at least 2 inches or at least 6 inches.

Preferably, the internal dimensions of the mixing chamber conform to the following:

$$\begin{matrix} \frac{L}{D} > 4 \\ L tube length \\ D tube diameter\end{matrix}$$

FIG. 2A illustrates a variant of the mixing chamber 30 which includes an internal helical baffle 15 which effectively provides a spiraling airflow path within the chamber 30 without increasing its overall length.

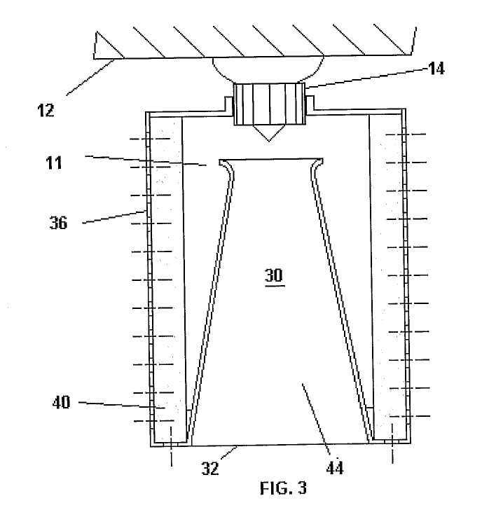

A different embodiment of the chamber 30 is shown in FIG. 3. This version is generally a truncated pyramid shape. This configuration increases the area of the open lower end 44, which increases entrainment rate, and creates lower more comfortable air velocities emanating from the device.

In operation, the entrainment of air within the chamber 30 causes a reduction of air pressure within the entrainment section 11 of the housing, which draws cabin air from outside the apparatus into the interior of the entrainment section 11, passing through the filter 40. Thus, the air exiting the chamber 30 contains a mixture of air from the aircraft ventilation system via the gaspers, and which is optionally filtered, purified and/or cleaned by the aircraft ventilation system, and entrained filtered air from the cabin interior in the region immediately surrounding the apparatus. Further, the air exiting the apparatus 10 is discharged in a more diffuse fashion which is lower in velocity than the air which would otherwise exit the gasper. This diffuse air stream tends to entrain minimal additional cabin air as it exits the apparatus, thus resulting in a substantially filtered, purified and/or cleaned stream of air impacting upon the passenger.

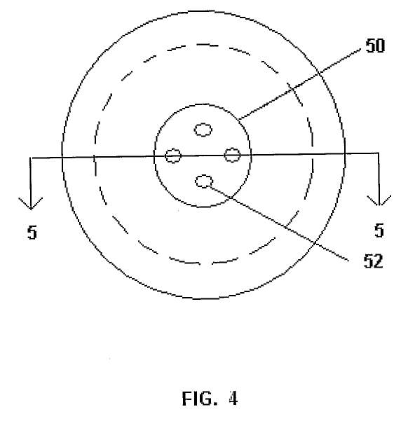

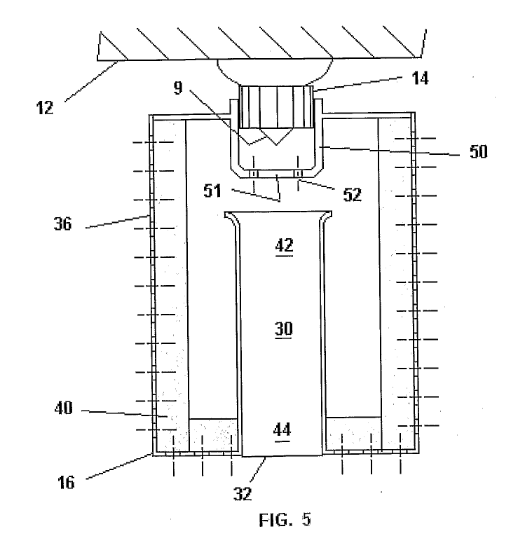

FIGS. 4 and 5 show another embodiment wherein an optional manifold 50 is mounted over the nozzle 9 so as to receive the airflow therefrom. The manifold 50 includes a lower face 51, perforated by multiple jet outlets 52. These jets 52 comprise narrow diameter tubes or openings directing multiple fine air streams into the open upper end 42 of the mixing chamber 30. The open lower end 44 of the chamber 30 exits through an opening within the housing 16 and forms an outlet for air to exit the apparatus into the interior of the aircraft cabin.

The total area of the plurality of openings 52 should equal the PAO flow divided by the PAO velocity:

$$\begin{matrix}{A}_{p} = \frac{{Q}_{q}}{{V}_{g}} \\ {V}_{g} = \sqrt{\frac{2 {P}_{g}}{ρ}}\end{matrix}$$

Aₚ Area of primary

Qₚ Normal PAO flow, i.e. 3 cfm

V_{g} Available PAO velocity

P_{g} PAO system gauge pressure

ρ density of air

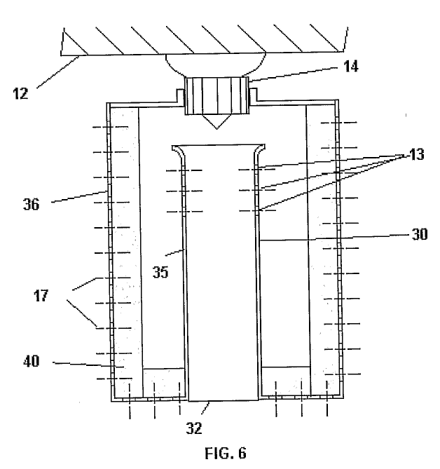

In a further embodiment shown in FIG. 6, the mixing chamber 30 also may be comprised of a permeable or perforated side wall 35. Preferably, the perforations 13 or other openings within the wall of the chamber 30 are confined to an upper portion thereof to maintain a device entrainment capability.

FIGS. 7 through 11 illustrate further embodiments of the present invention, comprising an integrated filtration, purification and/or cleaning and ventilation apparatus 90 intended to be built into the gasper structure rather than being installed over an existing conventional gasper. FIG. 7 shows a cross-sectional view of a typical aircraft cabin 80, including passenger seats 82, a cabin floor 84 and a PSU 12. Typically, one gasper unit per passenger is located in the PSU. The gaspers are fed by a main gasper air supply duct 86 which branches into multiple gasper air supply plenums 88 to feed gasper air to individual gasper units located above the passenger seats in the PSU 12. In this embodiment of the invention, the filtration, purification and/or cleaning and ventilation apparatus 90 is incorporated into the existing PSU and gasper air supply environment.

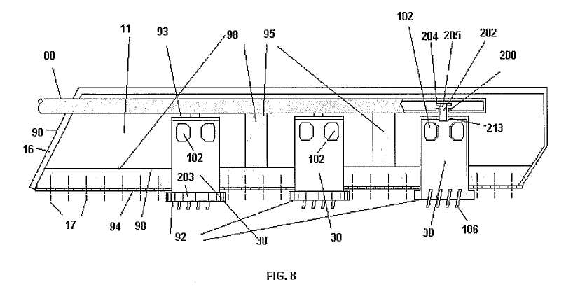

FIG. 8 shows a detailed view of the apparatus 90 containing three air supply units 92 intended for the occupants of one row of seats. The units 92 may be individually controlled by the occupants of the three seats within the specific row. Obviously, depending on the number of seats a greater or lesser number of units may be provided. The apparatus comprises a housing 16 which is substantially sealed apart from the specific inlets and outlets described herein. The housing 16 may be installed within a suitable space within the PSU such that the lower wall of the housing forms the underside of the PSU and is flush or substantially flush with the remainder of the PSU. The lower wall of the housing 16 comprises a grill 94 with perforations 17 that allow ambient cabin air to be drawn through a filter 98 and into the interior of the housing. The motive force for drawing air through the grill 94 and filter 98 is reduced pressure within the housing interior, as will be described below.

The interior of the housing is divided into compartments, with each compartment retaining a separate air supply unit 92. The compartments are separated from each other by walls 95 composed of a filtration medium 98, such that air may pass between the compartments but is filtered when it does so. This prevents any possible cross-contamination between air supply units and possible short-circuiting if one of the units is shut off.

The air supply plenum 88 enters into the housing 16 and branches to supply air to a plurality of air supply units 92 which are connected to the plenum 88 by a threaded tubular fitting 202. The fittings 202 are each fastened to a corresponding threaded orifice 200 within the pressurized air plenum 88 and include an internal bore 205 which forms a jet orifice for a high pressure airflow. The fitting 202 includes an disk-shaped valve seat 204 which when sealed abuts the upper rim of the orifice 200. Rotation of the fitting 202 elevates or lowers the fitting 202 thereby opening or closing the opening into the orifice 200 to control the flow of air from the plenum 88. The fitting 202 is fixedly mounted to the corresponding air supply unit 92, such that rotation of the unit 92 by grasping the external grasping surface 203 thereof, permits the user to rotate the fitting 202 thereby adjusting the flow rate through the unit 92.

The air supply units 92 further include a generally tubular mixing chamber 30 similar in structure and function to the mixing chamber of the embodiments described above. A cap 93 seals the upper end of the chamber 30. The fitting 202 enters the chamber 30 through an opening 213 in the cap, such that a stream of incoming air from the supply ducts may enter the chamber 30 through the bore 205. One or more air inlets 102 in the wall of the chamber 30 allow ambient air from the interior of the housing 16 to enter the chamber 30. Preferably, the inlets 102 are located adjacent to the upper end of the chamber 30 so as to maximize the entrainment and mixing effect as air passes through the chamber 30. Alternatively, the inlet or inlets 102 may extend through the cap 93. The chamber 30 is substantially larger in diameter than the bore 205, thereby providing an efficient means for entraining a substantial volume of air from the entrainment section 11 of the housing 16, when air enters the chamber 30 with a relatively high velocity through the inlets 102. The resulting air plume is thus permitted to expand within the chamber 30 in the same manner as in the first embodiment so as to entrain surrounding ambient air. Thus, as gasper air exits the jet orifice formed by bore 205, the momentum of the gasper air entrains the ambient cabin air by causing a reduction of pressure within the housing entrainment section 11. The pressure reduction draws ambient cabin air through the filter 98 such that the air within the housing, and which consequently is discharged to the passengers, is purified.

The unit 90 functions as a flow multiplier in that the volume of air directed to the passenger is increased, and as an air cleaner, diluting airborne ambient cabin air contaminants beyond what the ECS alone currently provides. The occupant is able to control the direction of the air supply through vanes 106, and the flow rate by rotation of the unit 92, according to his/her thermal comfort as well as health and odor protection needs.

The filter media 98 may comprise commercially available filter devices. The filter 98 may be augmented or replaced by a contaminant gas sorbent material, an electronic capture device, an electronic sterilization device such as a germicidal ultraviolet light, and/or an electronic oxidation device, with said device(s) shielded from passenger view and touch by the grill 94.

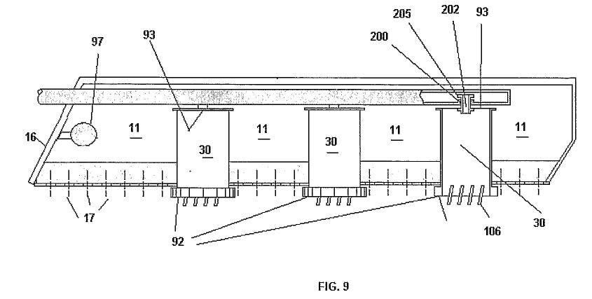

Another aspect (FIG. 9) provides mixing chambers 30 that admit the secondary air flow through a secondary opening in the cap 93. Rotation of the chamber 30 in one direction thus simultaneous closes the secondary opening and opens the air passages at the valve seat 200, thereby increasing the primary flow, while rotation in the reverse direction has the opposite effect. This allows for the removal of the filter dividers 95 and reduces the filter flow resistance. An air purifier 97 is optionally provided within the interior of the compartment entrainment section 11 for further purification of the entrainment air prior to entering the mixing tubes.

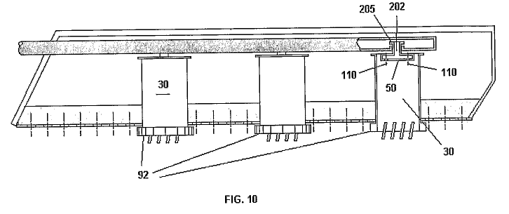

FIG. 10 shows an alternative embodiment of the apparatus 90. The fitting 202 includes at its lower end a manifold 50 which is located below the bore 205 and within the chamber 30. One or more holes 110, preferably multiple holes, are located in the bottom of the manifold 50 to alter the flow of the gasper air. This arrangement is particularly effective for entraining air with mixing tubes of less than 6″ in length.

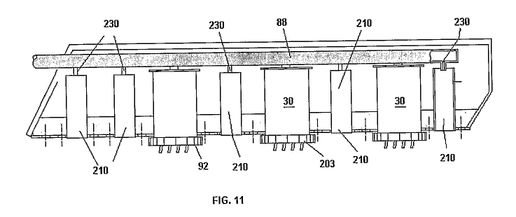

FIG. 11 illustrates an embodiment for use when the high velocity that is characteristic of PAOs is not desired. This aspect uses several units 92 as described above, and also several secondary mixing chambers 210 to deliver a low velocity, high quantity of air. Each mixing chamber 210 receives a primary airflow through a permanently open (non-valved) tube 230 which communicates with the plenum 88. The secondary air flow enters the chamber 210 through an open upper end thereof. Airflow through these secondary chambers may be bypassed by the flow through high velocity entrainment mixing chambers 30 by rotating the grasping surface 203. This embodiment provides entrainment and filtration for the occupant at all times via the secondary mixing chambers, except when he opens the unit 92 at which time he receives high velocity air for cooling and a smaller volume of entrained and filtered air. While the mix chambers 210 are shown as narrower than mix chambers 30, in fact the reverse may be true in order to maximize entrainment and filtration of the device when it is not being used for cooling the passenger with a high velocity air stream. Further, one or more holes 110, preferably multiple holes, may be located in the bottom of a manifold 50 to alter the flow of the gasper air into chambers 210 and increase entrainment filtration that way also.

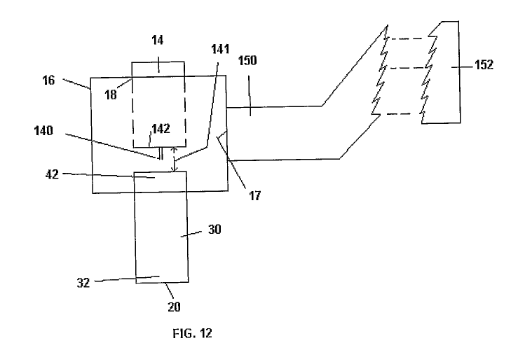

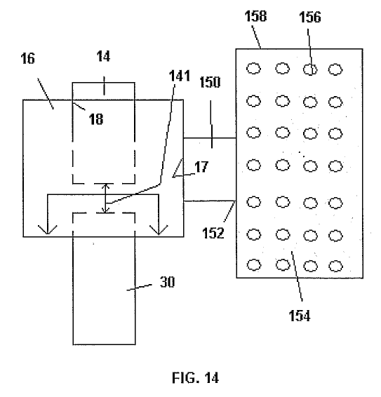

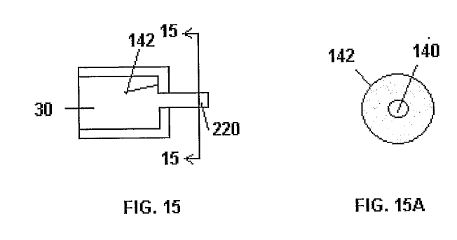

FIGS. 12 through 14 schematically illustrate ninth and tenth embodiments, in which the intake for entrained air is located at a distance from the air supply/discharge region. In this version, the primary air supply tube, such as a gasper 14, enters into the housing 16 through an opening 18. The housing 16 encloses the discharge end of the supply tube 14, and the receiving end of the tubular mixing chamber 30, which is positioned to leave a gap 141 between itself and the air supply tube to permit ambient air to be drawn into the chamber 30, in a similar fashion to the first embodiment described herein. The opening 140 of the air supply tube, seen in FIGS. 15 through 18, is partly obstructed with a disk 142 that may comprise various embodiments for controlling air flow in different ways. These embodiments will be described in more detail below. The corresponding intake opening of the mixing/entrainment chamber 30 is fully open. The housing 16 effectively seals the region around the gap against air inflow, except as is provided by the entrainment air inlet. The entrainment air enters the housing 16 via an inlet, which in turn is joined to a tube 150. The tube may be of any required length, although it must not be so long as to lose effectiveness. The tube communicates at its inlet end 152 with either a simple opening positioned within the cabin or outside the cabin at a location where the air drawn into the tube is reasonably clean; or alternatively, as seen in FIG. 14, the tube 150 is in fluid communication with a filter compartment 154, which has one or more walls that include openings 156 to permit the intake of air. One or more filters 158 line the walls either inside or outside of the compartment 154, so as to filter air entering the compartment 154. The filtered air is then drawn into the chamber 30 and discharged to the passenger. It will be seen that in this version, the filter compartment 154 may be located at a position close to the passenger, or alternatively at a position removed from any passengers so as to provide improved air quality.

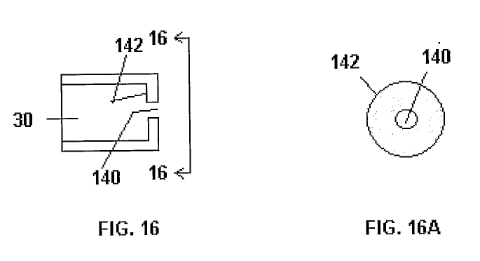

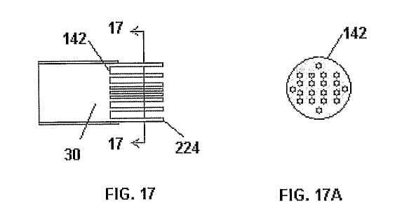

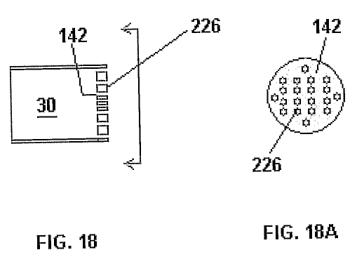

FIGS. 15 through 18 show four variants of the air supply tube 14, and in particular the portion of the air supply tube which is located within the interior of the housing 16. These variants may be adapted for use with any of the embodiments of the invention described herein. In the first variant of FIG. 15, the disk 142 includes a single central opening, with a tube 220 protruding outwardly therefrom so as to supply the primary air flow in a narrow, directed stream into or close to the entrance of the mix tube. The second variant shown in FIG. 16, provides a single opening essentially disposed within the disk 142, but without the tube of the first variant. In this case the primary air is directed to the mixing tube from a distance. FIG. 17 illustrates a third variant in which the disk 142 is provided with multiple openings, each of which is associated with a short, narrow tube 224, so as to provide multiple, narrow primary air streams. The fourth variant shown in FIG. 18 provides a disk 142 that includes multiple openings 226, as above, but without the tubes joined thereto.

### Example 1

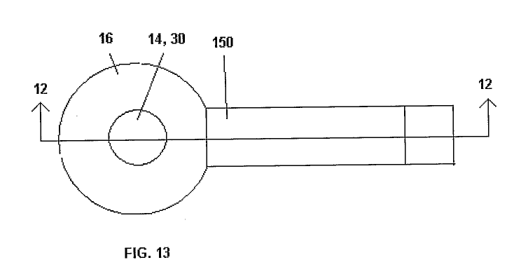

An experiment was performed in which a system similar to that illustrated in FIGS. 12 and 13 was set up to provide an assessment of device parameters on device performance, including:
Device air supply multiplier;
Filter surface area;
Filter particulate removal rate;
Single and multiple air supply jets;
2″ long to 18″ long mixing chambers;
Tubular and conical mixing chambers.

Air supply jets in front of the mixing chamber versus extending inside the mixing chamber.

Air was supplied at between 2 inch wc to 10 inch wc pressure into a 1.625″ i.d. tube via one or multiple jets. These jets were created both with 20 holes (total area=0.075 sq. inches) through a flat plate and via a 0.25 inch dia. tube. In the case of the flat plate jets, the plate was spaced away from the 1.625 inch i.d. secondary (mixing) tube at various distances from ¼ inch to a few inches.

Three mixing chambers were used. Two were tubes, one 2 inches long and the other 18 inches long, both with an i.d. of 1.625 inches. The third was a cone was a truncated cone (frustum) with a 1.625 inch i.d. intake and 3.5 inch i.d. outlet.

Air was entrained through a commercial 1 inch thick pleated filter typically used in residential furnace forced air circulation systems. Filter areas were 16″×20″ and 4″×5″.

Entrainment air was conducted to the entrainment capsule via a 1.625″ i.d. entrainment tube.

Pressure differences were quantified between the air supply tube and ambient, and the entrainment tube and ambient with a micromanometer to a 0.1 Pascal.¹ Velocities were measured with the micromanometer and a pitot tube. ¹ Pressure difference: Air Neotronics™ MP20S micro manometer, resolution 0.1 Pa.

Respirable suspended particulate aerosol count concentrations were quantified by 0.3 micron and larger and one micron and larger mass median diameters using an electronic laser particle counter.² ² Air RSP: Met One model 227B™, laser particle counter, sample rate 0.1 CFM, coincidence error+/−5% at 2×10⁶ particles/ft3; resolution 1 cpl; size fractions: >0.3 μm plus one of: >0.5, 1, 3 or 5 μm.

### EXPERIMENTAL FINDINGS

Flow multipliers up to 6 times were created. Single jet air supplies created the lowest entrainment rates in the shorter 2″ long conical and tubular mixing tubes. The 20 jet supply performed the best in the short mixing tubes, (better with the conical mixing chamber than the cylindrical mixing chamber) creating entrainment rates there comparable to those measured with the 18″ long mixing chamber.

The filter pressure drop constant was measured in a furnace system as between 0.15 (new filter) and 0.18 lb.sec/ft̂3 (used filter) at filter face velocities of 700 to 780 fpm. A 20 square inch filter surface did not retard entrainment significantly. In the furnace situation, this filter removed between 22 and 24% of 0.3 micron diameter and larger airborne particles, and 72 and 73% of 1 micron diameter and larger airborne particles. In contrast the new 20 square inch entrainment filter removed 86% of the 0.3 micron diameter and larger airborne particles, and 99% of the 1 micron diameter and larger airborne particles. Improved performance appeared to be due to lower impingement velocity.

### Mathematical Modeling

An incompressible ejector equation can be used to predict the entrainment airflow according to the above embodiments:

(Pⱼ−P_{amb})Aⱼ+(P₁−P_{amb})A₁−(P₂−P_{amb})A₂=\dot{m}₂V₂−(\dot{m}ⱼVⱼ+\dot{m}₁V₁)
\dot{m}ⱼ gasper mass flow slug/sec
\dot{m}₁ entrained mass flow slug/sec
\dot{m}₂ total mass flow slug/sec
Aⱼ gasper flow area 0.000529 ft²
A₁ mixtube entrance area 0.011743 ft²
A₂ mixtube exit area 0.012272 ft²
Pⱼ gasper exit static pressure lb/ft²
P₁ mixtube entrance static pressure (=Pⱼ) lb/ft²
P₂ mixtube exit static pressure (=P_{amb}) lb/ft²
P_{amb} cabin pressure lb/ft²
V₁ mixtube entrance velocity fps
V₂ mixtube exit velocity fps
Vⱼ gasper exit velocity fps

The filter pressure drop is based on □P=0.38 inches of water at 780 fpm face velocity:

P_{amb}−P_{f}=0.15Vⱼ
P_{f} internal filter pressure lb/ft²
V_{f} filter face velocity fps

The mixing chamber entrance velocity is related to the filter face velocity by continuity:

A_{f}V_{f}=A₁V₁

The mixing and diffusing chamber entrance pressure, P₁ (and the gasper exit pressure) is related to the internal filter, purifier and/or cleaner pressure, P_{f}, by Bernoulli's equation:

$${P}_{1} = {P}_{f} - \frac{1}{2} ρ {V}_{1}^{2}$$

$$ρ air density slug / {ft}^{3}$$

From continuity

A₂V₂=A₁V₁+AⱼVⱼ

The equations were all solved together for the system dimensions and flows shown above for a gasper pressure of 2″wc to obtain a flow multiplier of 6.0 (total ventilation flow 6.0 times that of the original gasper injection flow of 3 CFM) when no filter is present. The flow multiplier at sea level air density is 5.4 for a filter area of 0.25 ft² and 4.3 for a filter area of 0.0625 ft² for a filter pressure drop coefficient of 0.15 lb.sec/ft³. Doubling the filter pressure drop coefficient from 0.15 to 0.3 lb.sec/ft³ yields flow multipliers of 5.1 for a filter area of 0.25 ft² and 3.4 for a filter area of 0.0625 ft². At 8000 ft cabin air pressure, the flow multipliers drop slightly, for example from 5.5 to 5.4 for a filter pressure drop coefficient of 0.15 lb.sec/ft³ and a filter pressure drop coefficient of 0.15 lb.sec/ft³ (gasper flow now 3.5 cfm vs. 3 cfm at sea level). Maintaining the 3 CFM flow by decreasing the gasper flow area, the flow multiplier is 6.5 at 8000 ft cabin pressure. Increasing the gasper pressure to 10″wc increases the flow multiplier to 8.7 times at sea level when no filter is present with Aⱼ adjusted to maintain a 3 CM gasper flow. Example 2: Computational Fluid Dynamics Modeling Several embodiments can be analyzed using Computational Fluid Dynamics (CFD). The CFD models incorporate several aspects of each embodiment.

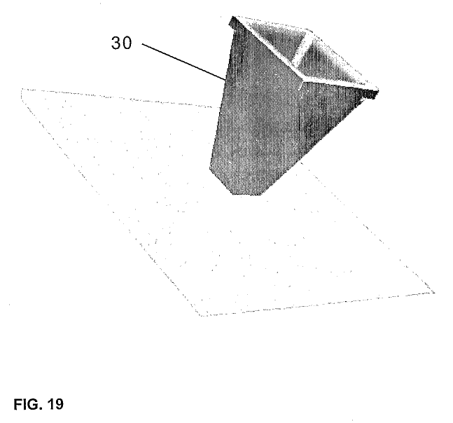

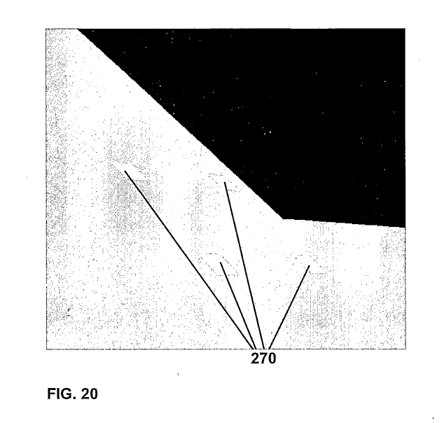

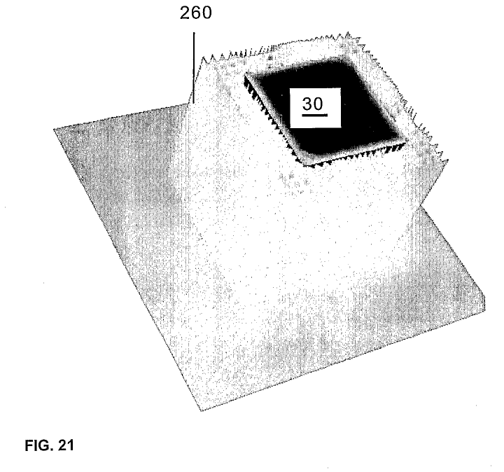

Example 2 consists of a portable device that attaches to the gasper which includes either four small primary jets 270 (FIG. 20) and a tapered mixing chamber 30 (FIG. 19). A rectangular 1 inch thick filter 260 (FIG. 21) surrounds a tapered mixing chamber. The filter outer dimensions are 6″×6″×6″ and the mixing chamber is 1.5″×1.5″ at the base and expands to 4″×4″ at the exit. There is a ½ inch gap between the plane of the orifices and the base of the mixing chamber 30 for entrained air to enter the diffuser. There are four jets 270 supplying 3 cfm at 94 fps at the base of the mixing chamber.

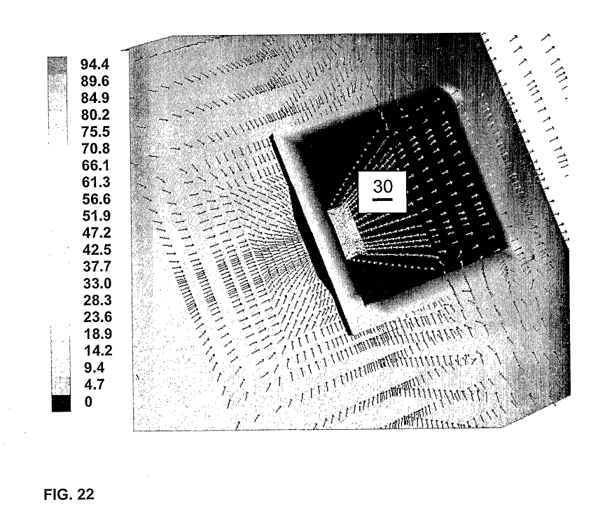

CFD results (in feet per second in FIG. 22) show that the air attaches well to the chamber and expands into the cabin (Filter not shown for clarity).

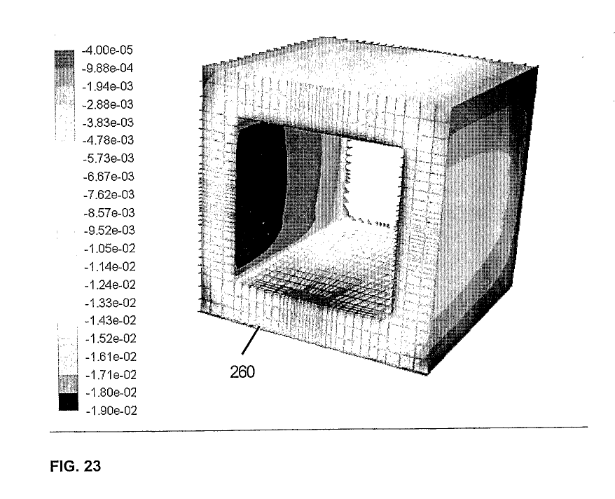

CFD results show a fairly uniform pressure gradient (lb/ft²) across the filter 260 (FIG. 23).

The amount of entrainment is 7.5 cfm for a total airflow of 10.5 cfm, and flow ratio of 10.5/3=3.5. The average exit velocity is reduced to 10.5 cfm/(4×4/144)=94.5 fpm or 1.58 fps.

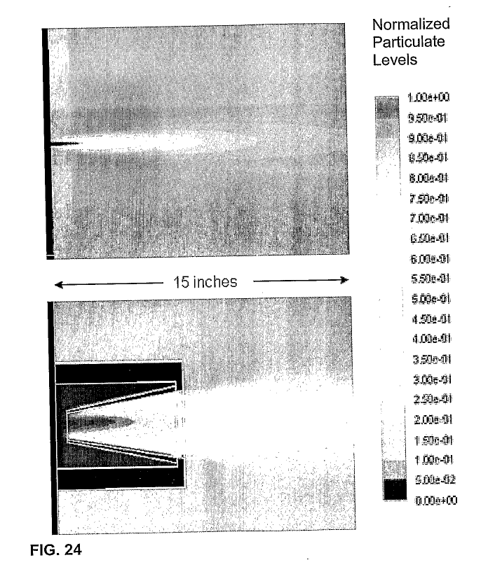

The concentration of particles 15 inches away from the gasper is reduced from 0.95 of the local concentration (conventional gasper) to 0.63 (normalized scale) or a 34% reduction in particulate levels (FIG. 24).

### Example 3

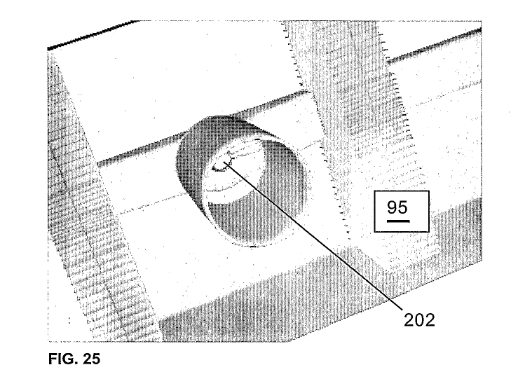

The further example of a CFD model is the built-in version described in connection with FIGS. 7-11 (FIG. 25). There is a single primary 94 feet per second jet orifice 202 with an area Of 0.07069 in² and a 1.5 inch diameter, 3 inch long mixing chamber. The lower surface and filter have been removed from the view to show the filter dividers 95, fitting 200 and plenum 88.

Although the present invention has been described by way of a detailed description wherein various embodiments and aspects of the invention have been described in detail, it will be seen by one skilled in the art that the full scope of this invention is not limited to the examples presented herein. The invention has a scope which is commensurate with the claims of this patent specification including any elements or aspects which would be seen to be equivalent to those set out in the accompanying claims.

1. An apparatus for providing an airflow to an individual, said apparatus for use with a source of pressurized air discharging a high velocity primary air stream, said apparatus comprising:
a housing having a primary inlet to receive said primary air stream, a secondary inlet to receive a secondary air stream composed of ambient air into the housing interior, and an outlet for discharge of a combined stream composed of said primary air stream and said ambient air;
an air mixing chamber at least partly within the interior of said housing having open first and second ends, said first end having at least one opening for receiving said primary air stream and said ambient air, said second end for discharging air outwardly from said apparatus through said housing outlet, said mixing chamber being configured to entrain said ambient air within said primary air stream when said primary air stream is directed through said chamber and to discharge from said second end a combined air stream composed of said ambient air stream and said primary air stream.

2. An apparatus as defined in claim 1 further comprising air treatment means for treating the secondary air stream.

3. An apparatus as defined in claim 2 wherein said air treatment means comprises any combination of an air filter, an air cleaner which sorbs or otherwise mitigates against contaminant gases, and an air purifier which kills or disables pathogens.

4. An apparatus as defined in claim 2 wherein said housing includes at least one wall, said secondary inlet comprises one or more perforations within said at least one wall, said treatment means abutting said wall and covering said one or more perforations.

5. An apparatus as defined in claim 1 further comprising a conduit to draw said ambient air from a location separated from said housing into said secondary inlet.

6. An apparatus as defined in claim 5, said conduit having first and second ends, said first end being in fluid communication with the interior of said housing and said second end being locatable at a position separated from said housing, and further comprising treatment means in fluid communication with said conduit for treating said ambient air prior to said ambient air entering into said housing.

7. An apparatus as defined in claim 3 comprising said air filter, wherein said air filter is within the interior of said housing.

8. An apparatus as defined in claim 1 wherein said source outlet comprises a gasper or personal air outlet.

9. An apparatus as defined in claim 1 wherein said mixing chamber is substantially tubular.

10. An apparatus as defined in claim 9 wherein the interior of said mixing chamber defines an airflow path which is essentially linear.

11. An apparatus as defined in claim 9 wherein the interior of said mixing chamber defines an airflow path which is effectively curved or coiled.

12. An apparatus as defined in claim 1 wherein said mixing chamber comprises one or more walls tapering outwardly towards said second end.

13. An apparatus as defined in claim 1 wherein said mixing chamber is at least one inch in length and at least 0.5 inches in internal diameter.

14. An apparatus as defined in claim 13 wherein said mixing chamber is at least 2 inches in length and is about 1.6 inches in internal diameter.

15. An apparatus as defined in claim 13 wherein the internal dimensions of said mixing chamber conform to the following dimensions:
$$\begin{matrix} \frac{L}{D} > 4 \\ L tube length \\ D tube diameter\end{matrix}$$

16. The apparatus of claim 1 further comprising a manifold within the interior of said housing covering said primary inlet to receive said primary air stream, said manifold having a plurality of outlet openings for directing a plurality of air streams into the first end of said mixing chamber.

17. The apparatus of claim 1 wherein said mixing chamber comprises a wall having openings therein to permit inflow of said ambient air from within the interior of said housing into said mixing chamber.

18. The apparatus of claim 8 further comprising an attachment for releasably attaching the apparatus to said gasper or personal air outlet.

19. The apparatus of claim 18 wherein said attachment comprises means to directly attach said housing to the exterior of said gasper or personal air outlet.

20. The apparatus of claim 1 comprising a plurality of source outlets, said source outlets being located within the interior of said housing, and a corresponding plurality of mixing chambers within said housing each associated with a corresponding source outlet, said plurality of chambers being optionally separated by internal dividers within said housing.

21. The apparatus of claim 20 wherein said mixing chambers comprise occupant controllable gaspers each having flow control means associated with the second end thereof.

22. The apparatus of claim 20 wherein said mixing chambers each comprise a sealed cap at said first end, said sources each comprise a jet orifice in fluid communication with said mixing chamber through an opening in said cap, and said chambers further include additional openings to permit ambient air from the interior of said housing to enter into said mixing chambers.

23. An airflow supply apparatus for a vehicle to remove contaminants and provide increased flowrate to an interior of the vehicle, the apparatus comprising:
a housing having at least one intake opening for receiving intake air from the interior of the vehicle into the housing and further having at least one exit for discharging air from the housing toward the interior;
a filter mounted on the housing for removing contaminants from said intake air; and
a nozzle in communication with a supply of pressurized air for releasing a flow of pressurized air into the housing;
wherein the nozzle is positioned generally adjacent to the opening of the housing such that the flow of pressurized air entrains said intake air from the interior of the vehicle to flow into the housing, through the filter, and through the exit for discharge from the housing together with air from the nozzle.

24. An apparatus of claim 23 further comprising a conduit to draw said intake air from a location remote from said housing into said secondary inlet.

25. The apparatus of claim 23 further comprising an attachment for releasably attaching said housing to said source of pressurized air.

26. A method of filtering and ventilating air in a passenger cabin, comprising the steps of providing an air mixing chamber to receive a primary stream of pressurized air from a source, providing a housing at least partly enclosing said mixing chamber, said housing including a primary inlet for said primary stream, a secondary inlet for ambient cabin air, and an outlet for a combined air stream composed of said ambient air and said primary stream, directing said primary air stream into a first end of said mixing chamber, generating a plume composed of said primary air stream within said mixing chamber including a turbulent boundary layer, entraining said ambient air within said boundary layer and thereby drawing said ambient air into said mixing chamber, and discharging said combined air stream from a second end of said mixing chamber through said housing outlet.

27. The method of claim 26 further comprising the step of treating said ambient air before entrainment into said primary stream.

28. The method of claim 27 wherein said treating comprises any combination of filtering, purifying and cleaning said ambient air.

29. The method of claim 26 further comprising the step of drawing said ambient air from a location remote from said housing and channeling said ambient air via a conduit into said secondary inlet.
